(19) United States
(12) Patent Application Publication
(10) Pub. No.: US 2023/0352789 A1
(43) Pub. Date: Nov. 2, 2023

(54) BATTERY ASSEMBLY STRUCTURE AND OUTDOOR AIR CONDITIONER

(71) Applicant: Shenzhen EnjoyCool Technology Co., Ltd, Shenzhen (CN)

(72) Inventor: Jiquan Wang, Shenzhen (CN)

(21) Appl. No.: 17/832,706

(22) Filed: Jun. 6, 2022

(30) Foreign Application Priority Data
Apr. 28, 2022 (CN) 202210462341.5

(51) Int. Cl. H01M 50/244; H01M 50/262; H01M 50/24; H01M 50/289

(52) U.S. Cl. CPC H01M 50/244; H01M 50/262; H01M 50/24; H01M 50/289

(57) ABSTRACT

A battery assembly structure and an outdoor air conditioner are provided. The battery assembly structure includes a main body and an assembly. The main body includes a housing, a battery accommodated in the housing, and a baffle integrally formed on the housing. At least part of the baffle is spaced apart from the housing to form a limiting gap. The assembly includes a bracket and a connector disposed on the bracket. The connector includes a limiting portion adapted to the limiting gap. The connector is capable of being rotated to rotate the limiting portion into the limiting gap or to disengage the limiting portion from the limiting gap.

### CROSS REFERENCE TO RELATED APPLICATION

The present disclosure claims priority to Chinese Patent Application No. 202210462341.5, filed Apr. 28, 2022, which is hereby incorporated by reference herein as if set forth in its entirety.

### BACKGROUND

### 1. Technical Field

The present disclosure relates to the technical field of charging equipment, and particular to a battery assembly structure and an outdoor air conditioner.

### 2. Description of Related Art

Most of compressor refrigeration air conditioners in the current market are not equipped with batteries, so that such compressor refrigeration air conditioners can only be used in places with power supply sockets, and need to carry power supply lines, which are inconvenient to use. Portable air conditioners for outdoor use in the same kind are provided with built-in batteries, which have limited capacity and short service time, leading to cumbersome air conditioners. In conventional detachable batteries for outdoor air conditioners, a plurality of foot pads of a main body of the air conditioner are placed in a plurality of mounting grooves on a battery housing for placing the foot pads, so as to achieve the detachable connection. However, such configuration has problems that it is not easy to easily place the plurality of foot pads in the plurality of mounting grooves, and the battery housing can only be placed under the main body of the air conditioner to prevent the plurality of foot pads from easily coming out of the plurality of mounting grooves.

### BRIEF DESCRIPTION OF THE DRAWINGS

In order to more clearly illustrate the technical solutions in this embodiment disclosure, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a schematic view of a battery assembly structure according to an embodiment of the present disclosure.

FIG. 2 is a schematic view of a main body of FIG. 1.

FIG. 3 is a partially enlarged view of position A in FIG. 2.

FIG. 4 is a schematic view of an assembly of FIG. 1.

FIG. 5 is a schematic view of a battery assembly structure according to another embodiment of the present disclosure.

Among them: 100, main body; 110, housing; 111, mounting groove; 112, first groove portion; 1121, middle circular groove; 1122, edge ring groove; 113, second groove portion; 114, limiting groove; 120, battery; 130, baffle; 131, limiting gap; 140, closure; 200, assembly; 210, bracket; 220, connector; 221, limiting portion; 222, annular support wall; 310, fixing member; 311, base; 312, top; 320, auxiliary member; 321, assembly groove; and 400, main switch.

### DETAILED DESCRIPTION

In order to facilitate the understanding of the present application, the present application will be described more comprehensively with reference to the relevant drawings. Preferred embodiments of the present application are shown in the drawings. However, the present application can be implemented in many different forms and is not limited to the embodiments described herein. On the contrary, the purpose of providing these embodiments is to make the disclosure of the present application more thorough and comprehensive.

It should be noted that when an element is referred to as being “fixed to” another element, it can be directly on another element or an intermediate element may also be present. When an element is considered to be “connected to” another element, it can be directly connected to another element or an intermediate element may be present at the same time. Terms “inner”, “outer”, “left”, “right” and similar expressions used herein are for illustrative purposes only, and do not mean that they are the only embodiments.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein, the term “and/or” includes any and all combinations of one or more of the associated listed items.

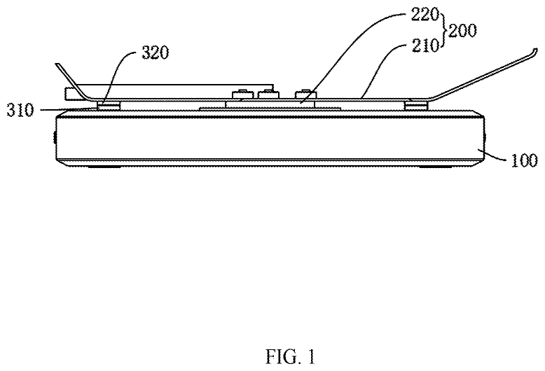

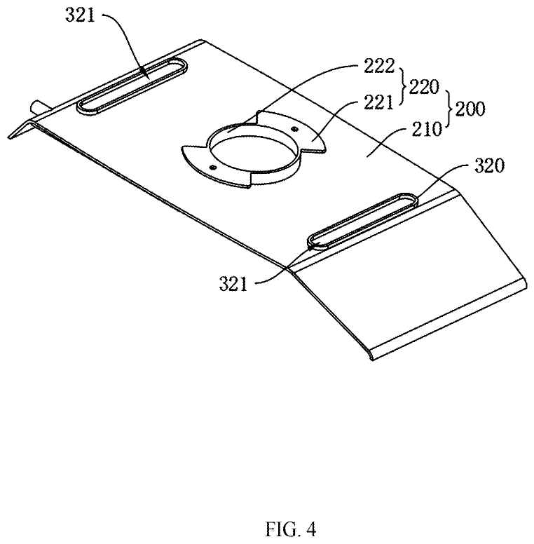

Referring to FIGS. 1 to 5, an embodiment of the present disclosure provides a battery assembly structure. The battery assembly structure in this embodiment is mainly applied to outdoor air conditioners, and certainly, may also be applied to other electrical appliances used outdoors, such as outdoor refrigerators, outdoor televisions, outdoor water heaters, and the like.

The battery assembly structure in this embodiment includes a main body 100 and an assembly 200 which is mainly used to connect the main body 100 and the outdoor electrical appliance together.

The main body 100 includes a housing 110, a battery 120 accommodated in the housing 110, and a baffle 130 integrally formed on the housing 110. At least part of the baffle 130 is spaced apart from the housing 110 to form a limiting gap 131. The assembly 200 includes a bracket 210 and a connector 220 disposed on the bracket 210. The connector 220 includes a limiting portion 221 adapted to the limiting gap 131. The connector 220 can be rotated to rotate the limiting portion 221 into the limiting gap 131 or to disengage the limiting portion 221 from the limiting gap 131. By rotating the connector 220, the limiting portion 221 can be rotated into the limiting gap 131, and in this case, the assembly 200 can stably fix the main body 100 to the outdoor electrical appliance. When the main body 100 needs to be detached from the assembly 200, the connector 220 is first rotated so that the limiting portion 221 is disengaged from the limiting gap 131, thereby detaching the main body 100 from the assembly 200. Since the main body 100 with the battery 120 is detachably connected to the outdoor electrical appliance, a user can separately carry the battery assembly structure and the outdoor electrical appliance, which is not only convenient for handling, but also can select the battery 120 having different capacities according to the requirements of the user, and also facilitates charging of the battery 120, greatly improving the convenience of the user, and the user is more willing to use the outdoor electrical appliances.

Further, the battery 120 is used to supply power to the outdoor electrical appliances. A mounting groove 111 is formed on the housing 110. The baffle 130 at least partially extends into the mounting groove 111. The mounting groove 111 includes a first groove portion 112 that is not overlapped with the baffle 130 and a second groove portion 113 that is overlapped with the baffle 130, in a depth direction of the mounting groove 111. The part of the baffle 130 extending into the mounting groove 111 is spaced apart from a bottom wall of the second groove portion 113 to form the limiting gap 131.

Further, the bracket 210 is used to be connected to the outdoor electrical appliances, preferably, the bracket 210 is detachably connected to the outdoor electrical appliances. The connector 220 is detachably mounted in the first groove portion 112. The connector 220 includes the limiting portion 221 adapted to the limiting gap 131, the connector 220 mounted in the first groove portion 112 can be rotated relative to the mounting groove 111 and rotate the limiting portion 221 into the limiting gap 131.

In this embodiment, when the main body 100 needs to be connected to the outdoor electrical appliance through the assembly 200, first, the connector 220 is aligned with the first groove portion 112, and the connector 220 is mounted in the first groove portion 112. Since the first groove portion 112 and the connector 220 are in a one-to-one correspondence, it is easier to align the first groove portion 112 and the connector 220, and more convenient for users to operate. Then, the connector 220 is rotated, and in this case, the limiting portion 221 can be rotated into the limiting gap 131, and the assembly 200 can stably fix the main body 100 to the outdoor electrical appliance. Since the connector 220 is detachably mounted in the first groove portion 112, when the main body 100 needs to be detached from the assembly 200, the connector 220 is first rotated, so that the limiting portion 221 is disengaged from the limiting gap 131, and in this case, the connector 220 can be detached from the first groove portion 112, and thus the main body 100 can be detached from the assembly 200. Since the main body 100 with the battery 120 is detachably connected to the outdoor electrical appliance, a user can separately carry the battery assembly structure and the outdoor electrical appliance, which is not only convenient for handling, but also can select the battery 120 having different capacities according to the requirements of the user, and also facilitates charging of the battery 120, greatly improving the convenience of the user, and the user is more willing to use the outdoor electrical appliances.

Preferably, the bracket 210 is in a form of plate, and the limiting portion 221 is in a form of slice. The limiting portion 221 is spaced apart from the bracket 210, so that the limiting portion 221 is more convenient to be cooperated with the limiting gap 131, and the structure is more reasonable.

In order to facilitate rotation of the connector 220 relative to the mounting groove 111, preferably, the mounting groove 111 is a circular groove. By providing the mounting groove 111 as a circular groove, the connector 220 can be rotated relative to the mounting groove 111 without being limited by a side wall of the mounting groove 111.

In order to improve the stability of the cooperation of the assembly 200 with the main body 100, preferably, two baffles 130 are provided, and the two baffles 130 are evenly spaced about a central axis of the mounting groove 111. By providing two baffles 130 and providing the two baffles 130 evenly spaced about the central axis of the mounting groove 111, the assembly stability of the assembly 200 and the main body 100 can be improved.

Certainly, in some embodiments, three, four, or other numbers of the baffles 130 may also be provided. By providing a plurality of baffles 130 and providing the plurality of the baffles 130 evenly spaced about the central axis of the mounting groove 111, the assembly stability of the assembly 200 and the main body 100 can be improved.

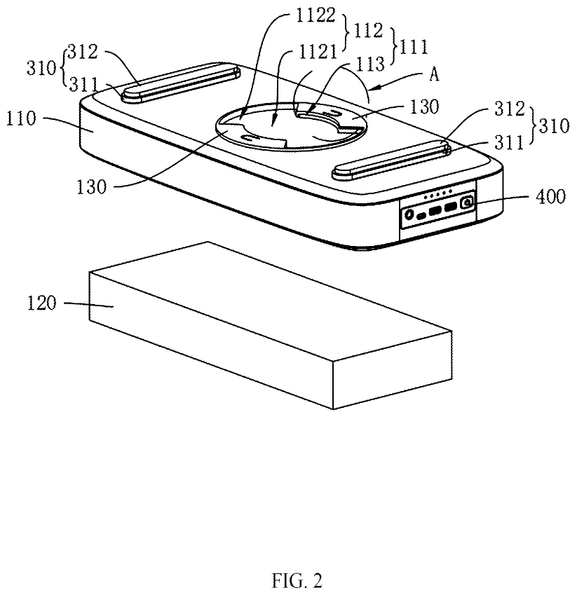

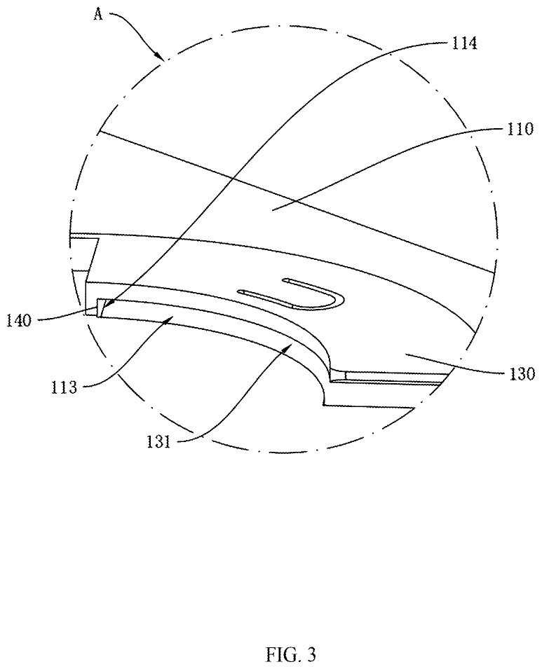

Referring to FIGS. 2 to 3, in an embodiment, the first groove portion 112 includes a middle circular groove 1121 and an edge ring groove 1122 surrounding the middle circular groove 1121. A central axis of the middle circular groove 1121 coincides with a central axis of the mounting groove 111. The connector 220 further includes an annular support wall 222 adapted to the middle circular groove 1121. The limiting portion 221 is integrally formed on an end, away from the bracket 210, of an outer side of the annular support wall 222, and the limiting portion 221 is adapted to the edge ring groove 1122. Since the central axis of the middle circular groove 1121 coincides with the central axis of the mounting groove 111, when the annular support wall 222 mounted in the middle circular groove 1121 is rotated relative to the middle circular groove 1121, the limiting portion 221 is not limited by the side wall of the edge ring groove 1122, so that the structure is more reasonable.

Preferably, the number of limiting portions 221 is the same as the number of baffles 130, and the number of baffles 130 is the same as the number of second groove portions 113, so that each of the baffles 130 can be cooperated with one limiting gap 131.

In a particular embodiment, the number of the edge ring grooves 1122 is the same as the number of the first groove portions 112, the shape and size of the edge ring grooves 1122 are substantially the same as those of the first groove portions 112, the shape of the limiting portions 221 is substantially the same as the shape of the first groove portions 112, and the size of the limiting portions 221 is slightly less than or equal to that of the edge ring grooves 1122. Since the shape and the size of the edge ring grooves 1122 are substantially the same as those of the first groove portions 112, the limiting portions 221 can be provided to be the maximum, so that not only the limiting portions 221 can be placed in the edge ring grooves 1122, but also the limiting portions 221 can be rotated from the edge ring grooves 1122 into the limiting gaps 131 in the second groove portions 113. When the limiting portion 221 is provided to be the maximum, the strength of the connector 220 is higher.

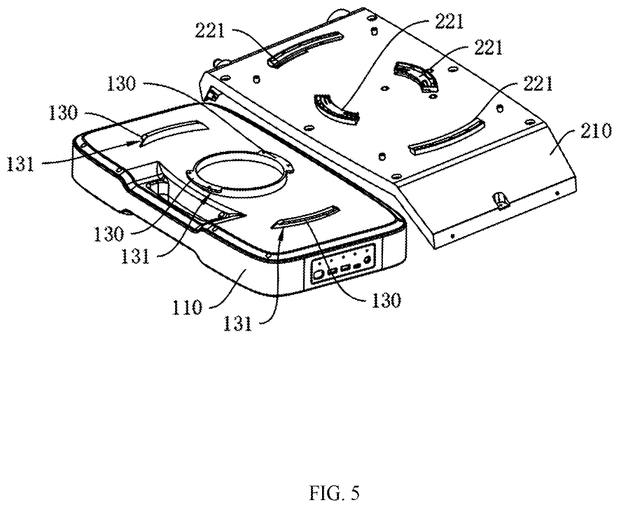

Referring to FIG. 5, in an embodiment, four baffles 130 are provided, and the four baffles 130 correspond to each other two by two, and four limiting gaps 131 are formed, and the four limiting gaps 131 also correspond to each other two by two. In addition, four limiting portions 221 are provided, and correspond to the four limiting gaps 131, respectively, so that the connection stability between the assembly 200 and the main body 100 can be improved.

In order to prompt and prevent errors in the assembly direction of the user, referring to FIGS. 2 to 3, in an embodiment, the main body 100 further includes a closure 140 connecting the baffle 130 to the bottom wall of the mounting groove 111, and the closure 140 is located between the limiting gap 131 and the edge ring groove 1122. One of two ends of the baffle 130 toward the two edge ring grooves 1122 is connected to the closure 140. Since one of two ends of the baffle 130 toward the two edge ring grooves 1122 is connected to the closure 140, when the connector 220 is rotated toward one end provided with the closure 140 and toward the limiting gap 131, the connector 220 cannot be rotated in this case due to the limitation of the closure 140. However, since the other end of the baffle 130 is not provided with the closure 140, the limiting portion 221 can be rotated from the edge ring groove 1122 into the limiting gap 131 by changing the direction of rotation of the connector 220. By means of the arrangement of the closure 140, the connector 220 can be quickly rotated into the limiting gap 131 in a correct assembly direction.

In order to prevent the limiting portion 221 from being unintentionally disengaged from the limiting gap 131, in an embodiment, the bottom wall of the second groove portion 113 is recessed to form a limiting groove 114 adapted to the limiting portion 221, and the limiting portion 221 can be mounted in the limiting groove 114 after being rotated to the limiting gap 131. Since the limiting portion 221 can be mounted in the limiting groove 114 after being rotated to the limiting gap 131, and the limiting groove 114 is recessed on the bottom wall of the first groove portion 112, when the limiting portion 221 is mounted in the limiting groove 114, the limiting portion 221 can be limited from rotating relative to the mounting groove 111, thereby preventing the limiting portion 221 from rotating out of the limiting gap 131.

In order to prevent the limiting portion 221 from being unintentionally disengaged from the limiting gap 131, referring to FIGS. 2 to 4, in another embodiment, the battery assembly structure further includes a fixing member 310 provided on the housing 110 and an auxiliary member 320 provided on the bracket 210 and adapted to the fixing member 310. The fixing member 310 is connected to the auxiliary member 320 when the limiting portion 221 is rotated into the limiting gap 131 and reaches a predetermined position. It should be noted that this embodiment may be used in combination with the limiting groove 114 in the above-described embodiments, specifically, when the limiting portion 221 is mounted in the limiting groove 114, the fixing member 310 and the auxiliary member 320 are connected together.

It should be noted that the predetermined position in the above-described embodiment preferably means that the limiting portion 221 substantially completely enter the limiting gap 131. Certainly, the predetermined position may be set according to specific requirements of the user, and the predetermined position may also be reached when the limiting portion 221 does not completely enter the limiting gap 131.

Further, the fixing member 310 includes a base 311 and a top 312 provided on the base 311, and the auxiliary member 320 is provided with an assembly groove 321 adapted to the top 312. The top 312 is disposed in the assembly groove 321 when the limiting portion 221 is rotated into the limiting gap 131 and reaches a predetermined position. Since the top 312 is disposed in the assembly groove 321 when the limiting portion 221 is rotated into the limiting gap 131 and reaches the predetermined position, the connector 220 can be limited from rotating relative to the mounting groove 111 when the limiting portion 221 is rotated into the predetermined position, thereby limiting the limiting portion 221 from being rotated out of the limiting gap 131. When detachment is required, the top 312 is first disengaged from the limiting groove 114, and then the connector 220 is rotated to disengage the limiting portion 221 from the limiting gap 131, thereby the connector 220 can be removed from the first groove portion 112.

It should be noted that shapes of the base 311, the top 312, and the assembly groove 321 are not limited. For example, in some embodiments, the base 311 is elongated, the top 312 is elongated, and the assembly groove 321 is elongated.

The battery assembly structure further includes a press-contact switch (not shown) provided on the housing 110, and the press-contact switch is electrically connected to the battery 120. When the limiting portion 221 is rotated into the limiting gap 131 and reaches the predetermined position, the press-contact switch abuts against the limiting portion 221 and is switched on.

In a particular embodiment, the press-contact switch is connected in series with a main switch 400 of the battery assembly structure, and the main switch 400 is used to control the battery assembly structure to output current to an external device. Since the press-contact switch is connected in series with the main switch 400 of the battery assembly structure, when the press-contact switch is switched on and the main switch 400 is switched on, current can be output to the external device. Thus, when the limiting portion 221 is not rotated to the predetermined position, the press-contact switch is switched off, and even if the main switch 400 is switched on, current cannot be output to the external device. In this way, it can be ensured that when the battery assembly structure is used by a user to supply power to the external device, the assembly should be accurately mounted on the main body 100, so that the assembly 200 and the main body 100 can be stably connected when the user uses the battery assembly structure, and it is possible to prevent the external device in use from falling from the main body 100 along with the assembly 200, especially when the main body 100 is mounted on a wall. If the assembly is not accurately mounted on the main body 100, the assembly 200 is more likely to fall off from the main body 100, thereby causing a safety hazard to the user.

Preferably, the press-contact switch is arranged on a side of the closure 140 facing the limiting gap 131. Certainly, the press-contact switch may also be mounted on other positions of the housing 110, such as on the bottom wall or side wall of the first groove portion 112, or on the bottom wall or side wall of the limiting groove 114.

In a particular embodiment, the top 312 is movably arranged on the base 311 in a direction perpendicular to the base 311, and specifically, a guide groove (not shown) is formed on the base 311 in the direction perpendicular to the base 311. The top 312 is movably arranged in the guide groove, the top 312 is a magnetic member, for example, the top 312 may be a permanent magnet, an electromagnet, or iron and iron-containing substances. An electromagnet (not shown) is provided on the bottom wall of the assembly groove 321, and the electromagnet is electrically connected to the press-contact switch. Since the electromagnet is electrically connected to the press-contact switch, when the press-contact switch is switched on, the electromagnet can communicate with the battery 120, that is, when the limiting portion 221 is rotated to the predetermined position, the press-contact switch abuts against the limiting portion 221 to be switched on, and in this case, the electromagnet is energized and magnetized, and the electromagnet will attract the top 312 and attract the top 312 into the assembly groove 321. Preferably, an elastic member is provided between the top 312 and the base 311, and the elastic member is able to pull the top 312 out of the assembly groove 321 after the electromagnet is de-energized. In this embodiment, when the assembly 200 needs to be mounted on the main body 100, the connector 220 is first mounted in the first groove portion 112, and then the connector 220 is rotated so that the limiting portion 221 is rotated into the limiting gap 131. When the limiting portion 221 is not rotated to the predetermined position, since the press-contact switch is switched off, the electromagnet is not energized and not magnetized, the top 312 is mostly located in the guide groove under the action of the elastic member, and the rotation of the auxiliary member 320 is not affected in this case. When the limiting portion 221 is rotated to the predetermined position, the auxiliary member 320 is located at the position corresponding to the top 312, the electromagnet is energized, and the electromagnet attracts the top 312 to be mounted in the assembly groove 321 against the elasticity. In this case, the connector 220 cannot rotate relative to the mounting groove 111 under the action of the top 312 and the assembly groove 321. If matched with the limiting groove 114 in the above embodiment, even if the battery assembly structure is mounted on a wall, it can still achieve the stable connection to the assembly 200, so that the outdoor electrical appliance can be mounted on the wall. When detachment is required, the electromagnet needs to be de-energized, for example, by switching off the main switch 400, and in this case, the limiting portion 221 can be rotated out of the limiting gap 131, and the assembly 200 can be disassembled from the main body 100.

An embodiment of the present disclosure further provides an outdoor air conditioner including an air conditioner body and the battery assembly structure in any of the above embodiments. The air conditioner body is mounted on a bracket 210. Since the main body 100 with the battery 120 is detachably connected to the outdoor electrical appliance, a user can separately carry the battery assembly structure and the outdoor electrical appliance, which is not only convenient for handling, but also can select the battery 120 having different capacities according to the requirements of the user, and also facilitates charging of the battery 120, greatly improving the convenience of the user, and the user is more willing to use the outdoor electrical appliances.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A battery assembly structure comprising:
a main body, comprising a housing, a battery accommodated in the housing, and a baffle integrally formed on the housing, at least part of the baffle being spaced apart from the housing to form a limiting gap; and
an assembly, comprising a bracket and a connector disposed on the bracket, the connector comprising a limiting portion adapted to the limiting gap, wherein the connector is capable of being rotated to rotate the limiting portion into the limiting gap or to disengage the limiting portion from the limiting gap.

2. The battery assembly structure according to claim 1, wherein the housing is provided with a mounting groove formed thereon, the baffle at least partially extends into the mounting groove; the mounting groove comprises a first groove portion that is not overlapped with the baffle and a second groove portion that is overlapped with the baffle in a depth direction of the mounting groove, a part of the baffle extending into the mounting groove is spaced apart from a bottom wall of the second groove portion to form the limiting gap; the connector is detachably mounted in the first groove portion, and the connector mounted in the first groove portion is capable of being rotated relative to the mounting groove and rotating the limiting portion into the limiting gap.

3. The battery assembly structure according to claim 2, wherein the mounting groove is a circular groove, two baffles are provided, the two baffles are evenly spaced about a central axis of the mounting groove; the first groove portion comprises a middle circular groove and an edge ring groove surrounding the middle circular groove, a central axis of the middle circular groove coincides with a central axis of the mounting groove; the connector further comprises an annular support wall adapted to the middle circular groove, the limiting portion is integrally formed on an end, away from the bracket, of an outer side the annular support wall, and the limiting portion is adapted to the edge ring groove.

4. The battery assembly structure according to claim 3, wherein the main body further comprises a closure connecting the baffle to a bottom wall of the mounting groove, the closure is located between the limiting gap and the edge ring groove, one of two ends of the baffle toward two edge ring grooves is connected to the closure.

5. The battery assembly structure according to claim 2, wherein the bottom wall of the second groove portion is recessed to form a limiting groove adapted to the limiting portion, and the limiting portion is capable of being mounted in the limiting groove after being rotated to the limiting gap.

6. The battery assembly structure according to claim 2, further comprising a fixing member provided on the housing and an auxiliary member provided on the bracket and adapted to the fixing member, wherein the fixing member is connected to the auxiliary member when the limiting portion is rotated into the limiting gap and reaches a predetermined position.

7. The battery assembly structure according to claim 6, wherein the fixing member comprises a base and a top provided on the base, the auxiliary member is provided with an assembly groove adapted to the top, and the top is disposed in the assembly groove when the limiting portion is rotated into the limiting gap and reaches the predetermined position.

8. The battery assembly structure according to claim 7, further comprising a press-contact switch provided on the housing, wherein the press-contact switch is electrically connected to the battery, the press-contact switch abuts against the limiting portion and is switched on when the limiting portion is rotated into the limiting gap and reaches the predetermined position.

9. The battery assembly structure according to claim 8, wherein the base is provided with a guide groove in a direction perpendicular to the base, the top is movably arranged in the guide groove; the top is a magnetic member, and an electromagnet is provided on a bottom wall of the assembly groove, and the electromagnet is electrically connected to the press-contact switch.

10. An outdoor air conditioner comprising an air conditioner body and the battery assembly structure according to claim 1, the air conditioner body being mounted on the bracket.
